(19) United States
(12) Patent Application Publication
(10) Pub. No.: US 2016/0232470 A1
(43) Pub. Date: Aug. 11, 2016

(54) Automated Generation of Process Flow Charts

(71) Applicant: Keguo Zhou, Shanghai (CN)

(72) Inventor: Keguo Zhou, Shanghai (CN)

(21) Appl. No.: 14/615,266

(22) Filed: Feb. 5, 2015

(51) Int. Cl. G06Q 10/06

(52) U.S. Cl. CPC G06Q 10/06316

(57) ABSTRACT

Techniques are described for generating a process flow chart. A process flow chart is a visualization that describes the process for completing a business activity of a software application. An example of a business activity within a business application can be a sale of goods. The sale of goods can have multiple steps, including sales quotation, sales order, delivery, and optionally return of goods. Each step is performed by executing a function of the software application. In some embodiments, a process flow chart can be generated in response to a request to perform a function of the software application. The function can be one of many functions which are performed during a business activity. The software application can perform the requested function and also provide the process flow chart so that the user can become familiar with the other steps in the business activity.

### BACKGROUND

Enterprise resource planning (“ERP”) is business management software that includes a suite of software applications. The ERP system can perform a variety of business activities. For example, ERP systems can manage business resources such as cash, raw materials, and production capacity. ERP systems can also manage the status of business commitments such as orders, purchase orders, and payroll. Business activities are often complex and require performing functions across different software applications.

Each business activity is associated with a process flow to perform the given business activity. A user can follow the process flow to perform a series of functions within the ERP system. For example, sales quotation, sales order, delivery, and return functions can be part of a process that is related to the business activity of selling goods. Given the vast array of business activities that can be performed by the ERP system, a user is often unfamiliar with the process associated with a given business activity. As a result, it can be confusing and cumbersome for users, particularly new users, to navigate and perform business activities within the ERP system.

### SUMMARY

In one embodiment, a computer-implemented method receives, by a processor, a request for a target business function provided by a software application, identifies, by the processor, at least one of: a first business function which the target business function depends on and a second business function which is dependent on the target business function, links, by the processor, the at least one of the first business function and the second business function to the target business function as part of a linked list, for each identified business function, recursively repeating the identifying step to identify additional business functions having dependencies with the identified business function and the linking step to add the additional business functions to the linked list, and presenting, by the processor, a graphical representation of the linked list.

In one example, the method further comprises presenting, by the processor, a form configured to receive an input parameter for the target business function. The method can further comprise applying, by processor, a visual indicator to an icon representing the target business function in the linked list.

In another example, the method further comprises receiving, by the processor, the input parameter, saving, by the processor, the input parameter, determining, by the processor and from the linked list, a subsequent business function that depends on the target business function, presenting, by the processor, a subsequent form associated with the subsequent business function, and applying, by the processor, a visual indicator to the subsequent business function in the linked list. The method can further include automatically populating, by the processor, a field within a subsequent form with the input parameter.

In another example, the first business function is configured to generate an output parameter which is used as input for the target business function.

In another example, the second business function is configured to receive output generated by the target business function as an input parameter.

In another embodiment, a non-transitory computer readable storage medium stores one or more programs comprising instructions for receiving a request for a target business function provided by a software application, identifying at least one of: a first business function which the target business function depends on and a second business function which is dependent on the target business function, linking the at least one of the first business function and the second business function to the target business function as part of a linked list, for each identified business function, recursively repeating the identifying step to identify additional business functions having dependencies with the identified business function and the linking step to add the additional business functions to the linked list, and presenting a graphical representation of the linked list.

In another embodiment, a computer implemented system comprises one or more computer processors and a non-transitory computer-readable storage medium. The non-transitory computer-readable storage medium comprises instructions, that when executed, control the one or more computer processors to be configured for receiving a request for a target business function provided by a software application, identifying at least one of: a first business function which the target business function depends on and a second business function which is dependent on the target business function, linking the at least one of the first business function and the second business function to the target business function as part of a linked list, for each identified business function, recursively repeating the identifying step to identify additional business functions having dependencies with the identified business function and the linking step to add the additional business functions to the linked list, and presenting a graphical representation of the linked list.

The following detailed description and accompanying drawings provide a better understanding of the nature and advantages of the present disclosure.

### BRIEF DESCRIPTION OF THE DRAWINGS

FIG. 1 illustrates a computing system for generating a process flow chart in response to a requested business function according to one embodiment;

FIG. 2 illustrates a business activity according to one embodiment;

FIG. 3 illustrates a business functions database according to one embodiment;

FIG. 4 illustrates a graphical user interface containing a search bar according to one embodiment;

FIG. 5a illustrates a graphical user interface containing a process flow chart according to one embodiment;

FIG. 5b illustrates a graphical user interface containing a process flow chart according to one embodiment;

FIG. 6 illustrates a graphical user interface containing a process flow chart according to one embodiment;

FIG. 7 illustrates a graphical user interface containing a process flow chart according to one embodiment;

FIG. 8 illustrates a graphical user interface containing a process flow chart according to one embodiment;

FIG. 9 illustrates a process according to one embodiment; and

FIG. 10 illustrates an exemplary computer system according to one embodiment.

### DETAILED DESCRIPTION

In the following description, for purposes of explanation, numerous examples and specific details are set forth in order to provide a thorough understanding of the present disclosure. It will be evident, however, to one skilled in the art that the present disclosure as expressed in the claims may include some or all of the features in these examples alone or in combination with other features described below, and may further include modifications and equivalents of the features and concepts described herein.

Described herein are techniques for generating a process flow chart. A process flow chart is a visualization that describes the process for completing a business activity of a software application. An example of a business activity within a business application can be a sale of goods. The sale of goods can have multiple steps, including sales quotation, sales order, delivery, and optionally return of goods. Each step is performed by executing a function of the software application. In some embodiments, a process flow chart can be generated in response to a request to perform a function of the software application. The function can be one of many functions which are performed during a business activity. The software application can perform the requested function and also provide the process flow chart so that the user can become familiar with the other steps in the business activity.

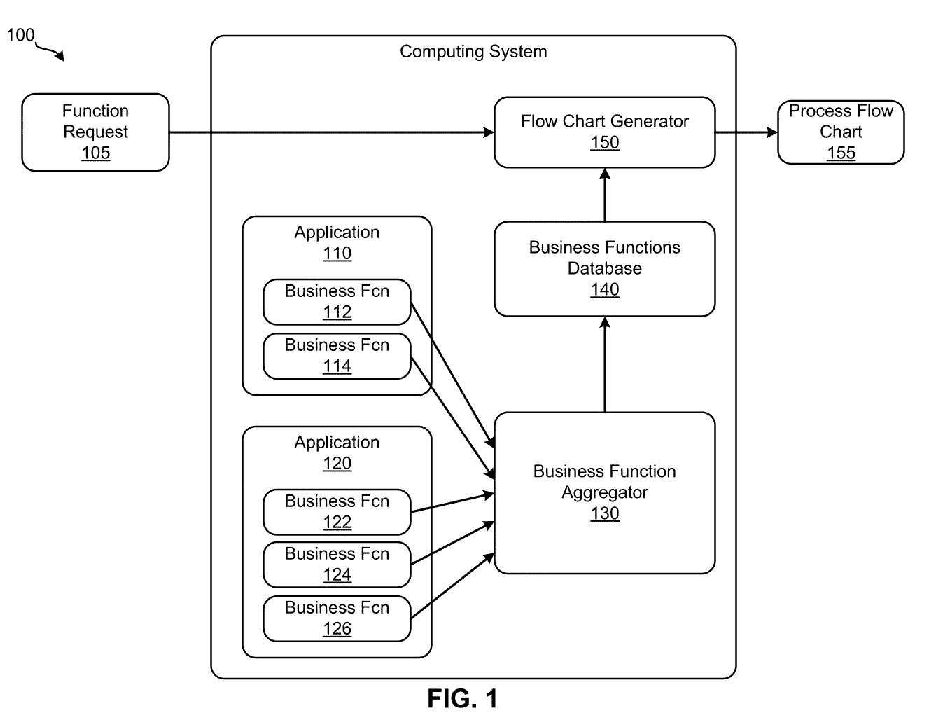

FIG. 1 illustrates a computing system for generating a process flow chart in response to a requested business function according to one embodiment. The process flow chart can present one or more steps that make up a business activity. One of the steps can be the execution of the requested business function. System 100 can be located on the client side or the server side. In one example, system 100 can be a client-side device that is executing one or more software applications. In response to received user input for a function request, system 100 can generate a process flow chart or guideline that is related to the requested function. In another example, system 100 can be a server-side device. The server-side device can execute software applications and interface with a client device to receive instructions for the software applications. In response to an instruction from the client device to request a business function, system 100 can generate a process flow chart (or other guideline) that is related to the requested business function and return the process flow chart to the client device where the process flow chart is presented to the customer.

System 100 includes application 110 and application 120. Applications 110 and 120 are software applications that are executed on system 100. Each application can be configured to perform various business functions. A business function is an operation, action, or task which can be performed by the software application. Examples of business functions include sales quotation, sales order, delivery, and optionally return of goods. The software application can be configured to perform various business activities. Each business activity can include a series of business functions, which when performed, can complete the business activity. Here, application 110 includes business functions 112 and 114 while application 120 includes business functions 122, 124, and 126. In some examples, a business activity can include a series of business functions from multiple applications.

System 100 further includes business function aggregator 130. Business function aggregator 130 is configured to periodically aggregate the business functions available within applications of system 100. In one embodiment, business function aggregator 130 can aggregate the business functions within the applications on a predefined schedule. For example, business function aggregator 130 can query the applications of system 100 for business functions on a weekly basis. In another embodiment, business function aggregator 130 can aggregate the business functions in response to a trigger. For example when a software application has been updated (thus resulting in a change to the business functions of the software application), the software application can transmit a trigger to business function aggregator 130. Business function aggregator 130 can collect the available business functions in response to the trigger.

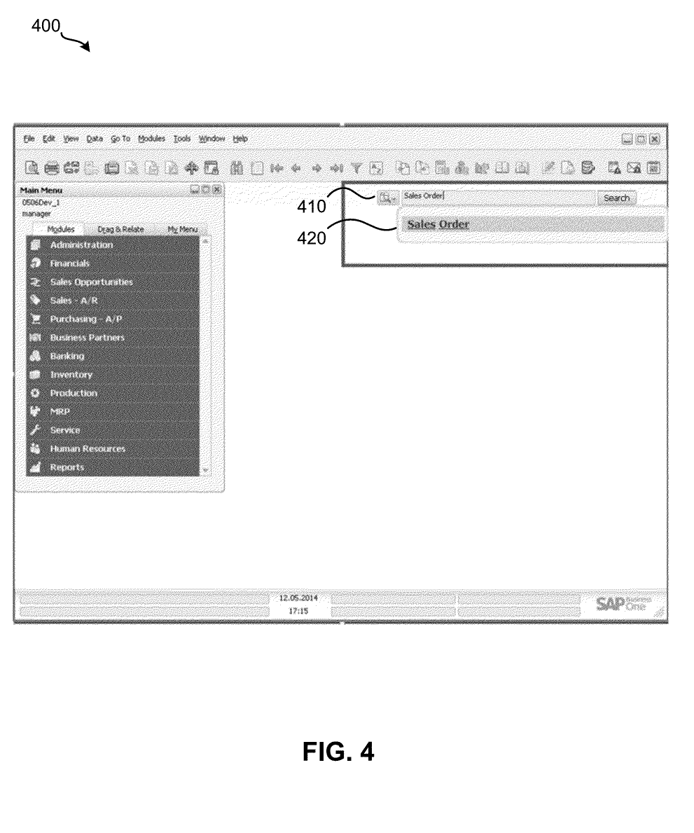

System 100 further includes business functions database 140. Business functions database 140 can store the business functions which are available within the applications of system 100. An exemplary business functions database is described below in FIG. 3. System 100 further includes flow chart generator 150. Flow chart generator 150 is configured to generator process flow chart 155 in response to receiving function request 105. In one embodiment, function request 105 can be received as a keyword search for a business function. When the business function is found, flow chart generator 150 can generate process flow chart 155 to be presented to the user. In one embodiment, process flow chart 155 can be presented simultaneously with a webpage or window that is associated with the requested function.

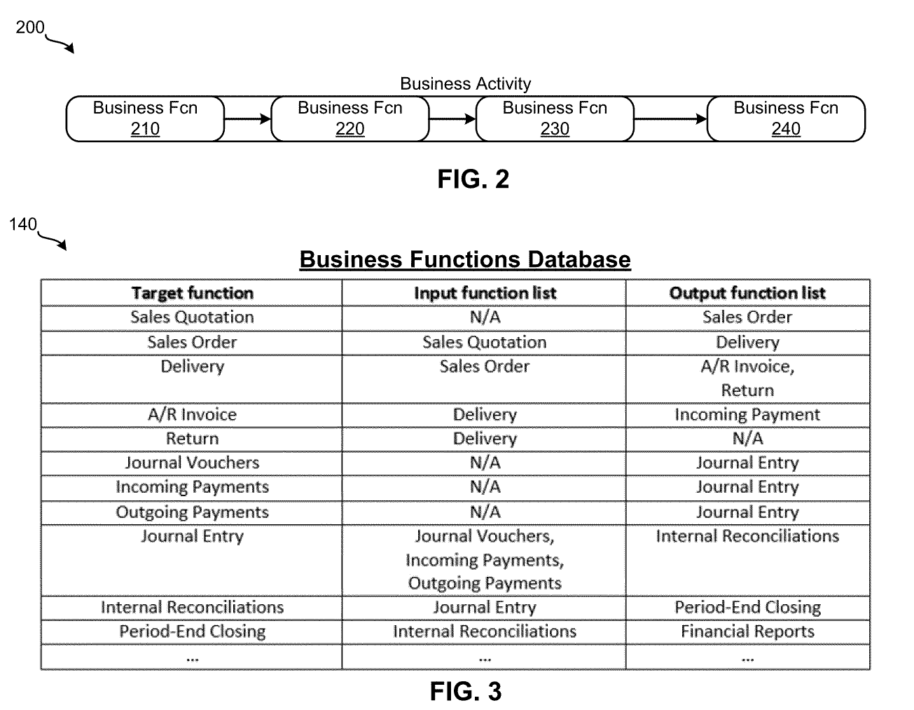

FIG. 2 illustrates a business activity according to one embodiment. The business activity can be performed on a business object of the software application. As shown, business activity 200 includes multiple business functions. Each business function is connected to another business function. To perform business activity 200, business function 210 is performed, followed by business function 220, business function 230, and lastly business function 240. Business activity 200 is completed once business function 240 has been performed. If a user wishes to perform business activity 200, the user would perform the business functions within business activity 200 in the order shown.

FIG. 3 illustrates a business functions database according to one embodiment. As described above, business functions database 140 stores data on the business functions which are available within the software applications of the computer system. Each business function is represented by a row within business functions database 140. In some embodiments, business functions database 140 is configured to store the dependency data between business functions. Business functions database 140 can be configured to map a given business function to other business functions having dependencies with the given business function. For a given business function (e.g., target business function), business functions database 140 can store in a first column the name (or other identifier) of the target business function, store in a second column an input function list containing any business functions which the target business function depends on, and the third column stores an output function list containing any business functions which depend on the target business function.

In one embodiment, the dependencies can be related to the input and output parameters of the business functions. An input parameter is a value which is received by the business function as input while an output parameter is a value which is generated by the business function as output. In one example, a target business function can “depend on” another business function if an input parameter of the target business function is output by the other business function. For instance, business function B can depend on business function A if an output parameter of business function A is an input parameter for business function B. Similarly, a business function can “depend on” the target business function if an output parameter of the target business function is used as an input parameter for the business function. Thus, business functions database 140 can identifies dependencies based on input and output parameters of the business functions. For example, the target business function titled “sales quotation” does not have an input function list (meaning that the input parameters for the sales quotation business function do not come from the output of other business functions) and has an output function list containing the “sales order” business function (meaning that the output of the sales quotation business function is used as an input parameter for the sales order business function).

In another embodiment, the dependencies can be related to the sequence of defined business activities. Predefined business activities of the software application can define a sequence for the business functions. For example, business activity 200 of FIG. 2 defines the business activity as business function 210 followed by business function 220 followed by business function 230 followed by business function 240. For a target business function, a business function which is processed directly prior the processing of the target business function is known as a business function which the target business function depends on. Similarly, a business function which is processed directly after the processing of the target business function is known to depend on the target business function. Business functions database 140 can store these dependencies. When business activities are altered, business function aggregator 130 can update business functions database to update the dependencies of the business activities.

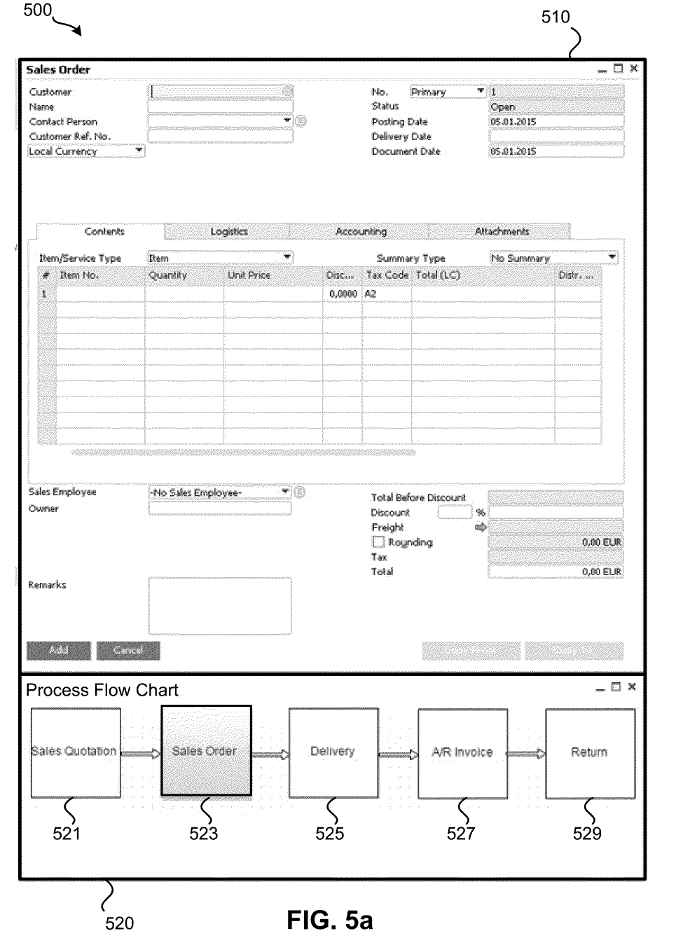

Flow chart generator 150 can generate a process flow chart in response to a function request. In some embodiments, the function request can be in the form of a keyword search for an available business function. For example, a query for a business function can be received in a search bar of a graphical user interface. In response to the query, the application can return a form associated with the business function. The user can in turn enter information into the form to perform the business function. As described above, the business function can be performed on a business object that can be manipulated by at least software application of the computer system. FIG. 4 illustrates a graphical user interface containing a search bar according to one embodiment. Computing system 100 can generate graphical user interface 400 for presentation to the user. Graphical user interface 400 contains search bar 410. Search bar 410 is configured to receive user input in the form of one or more keywords. Based on the one or more keywords, the software application can query for a business function having a name which contains the one or more keywords. Here, the query includes the keywords “sale” and “order.” In response to the keywords received, the software application returns a suggestions list of business functions which contain the keywords. Here, suggestions list 420 includes a business function titled “sales order.”

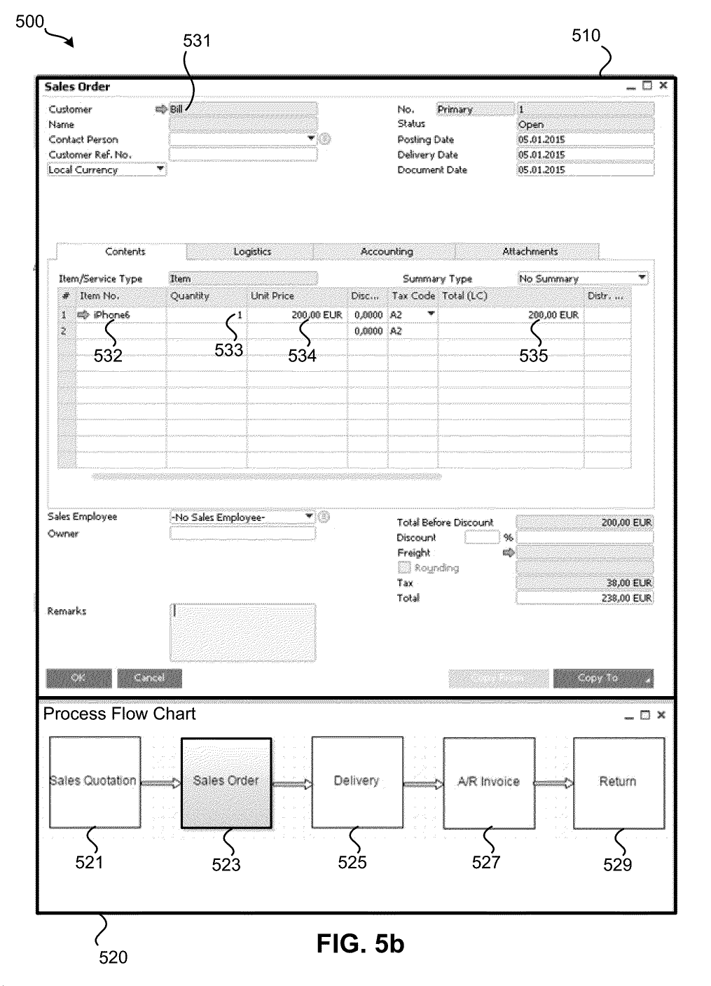

FIG. 5a illustrates a graphical user interface containing a process flow chart according to one embodiment. Computing system 100 can generate graphical user interface 500 in response to receiving a function request. In one example, the function request can be received as user input entered into a search bar, such as search bar 410 in graphical user interface 400. Here, graphical user interface 500 can be presented to the user in response to a function request for a sales order form. Computing system 100 can generate a new business object to represent the sales transaction in response to the function request for the sales order form. Computing system 100 can then retrieve a sales order form associated with the sales order business transaction and generate window 510 to present the sales order form within graphical user interface 500. As shown, the sales order form includes multiple fields for receiving input data describing the sales order of the new business object. Input data can be entered into the sales form. When the sales form is saved, computing system 100 can save the input data within the sales transaction business object.

Graphical user interface 500s can further include window 520 which is configured to present a process flow chart. The process flow chart is configured for visualizing the steps that are within the process of completing a sales transaction. As shown, the process flow chart includes a sales quotation step 521, a sales order step 523, a delivery step 525, an A/R invoice step 527, and a return step 529. Each step can be presented as an icon within window 520. Steps within process flow chart 520 can be In one embodiment, computing system 100 can apply a visual indicator to the step which is associated with the form being presented within window 510. Here, step 523 which is associated with the form being presented within window 510 is highlighted. Advantages to highlighting step 523 include notifying the user of the form which is being presented within window 510 while also notifying the user of the steps of the business activity which follow the current step. In one embodiment, computing system 100 can generate process flow chart by querying a business functions database for business functions which have dependencies with the target business function. Once the identified business have been identified, computer system 100 can link together the business functions to generate the process flow chart. In some examples, the business functions can be linked according to the dependencies between business functions to generate the process flow chart.

FIG. 5b illustrates a graphical user interface containing a process flow chart according to one embodiment. FIG. 5b illustrates graphical user interface 500 with a few fields which have received input data. As shown, window 510 has received input data in fields 531-535. One or more of these fields can be auto-populated in response to the entry of input data within another field. For example, field 534 describing the per-unit price can be automatically populated in response to receiving input data in field 532 describing the sales item (which here is a smart phone). Similarly, field 535 describing the total cost can be automatically populated in response to receiving input data in field 532 describing the sales item and field 533 describing the quantity of the sales item. Graphical user interface 500 contains window 520 which is the same as window 520 in graphical user interface 500 of FIG. 5a. As shown, a visual indicator can remain applied on step 523 to imply that the form currently being filled in is related to the sales order step 523. Once input data has been entered into the form being presented within window 510, computer system 100 can save the input data as part of the business object.

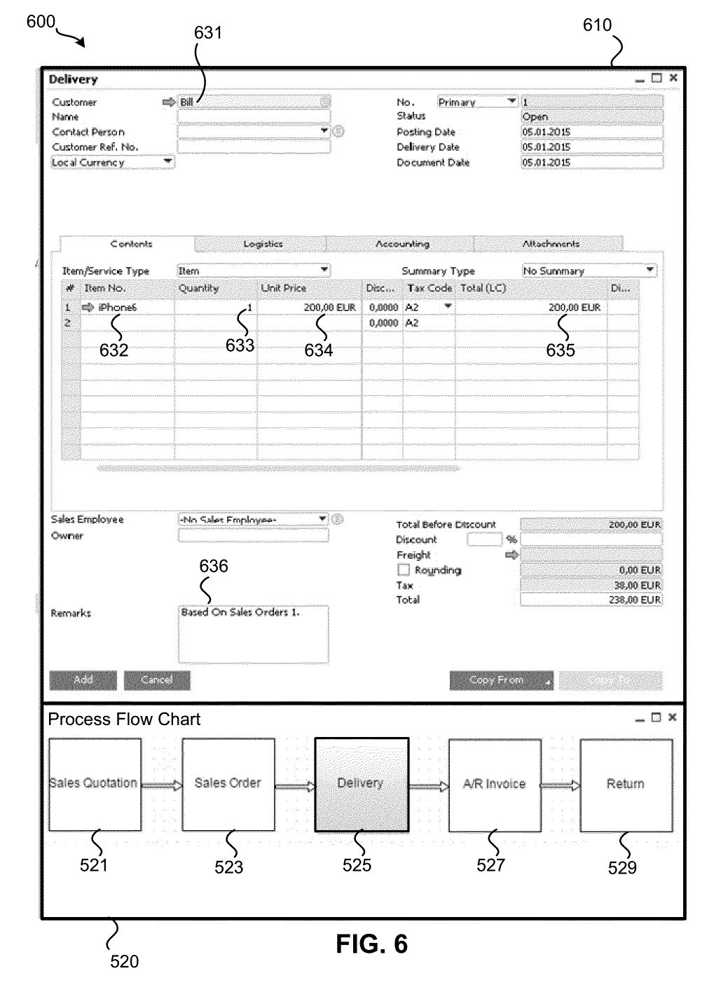

In one embodiment, computer system 100 can be configured to automatically guide a user through the business activity. When input data for a form is saved, computer system 100 can automatically present a form for the subsequent business function of the business activity. Advantages of automatically presenting the next form for the subsequent business activity include a simpler process for the user since the user does not need to manually navigate to the next business function. FIG. 6 illustrates a graphical user interface containing a process flow chart according to one embodiment. Graphical user interface 600 includes window 610 and window 520. Window 610 contains a form for a delivery business function while window 520 contains a process flow chart for the business activity. The process flow chart is presented where step 525 is highlighted to signify that the form being presented in window 610 is related to the delivery business function.

As shown here, a few fields within the form being presented in window 610 have been automatically populated. The data used to auto-populate the fields can come from a previously filled form, such as the form presented in window 510 of FIG. 5b. For example, the input data from the previously filled form can be stored on the business object. When the form is being presented in window 610, fields of the form having data stored on the business object can be automatically populated with the data stored on the business object. Here, fields 631-635 can be automatically populated according to data stored on the business object. In some examples, computer system 100 can also automatically populate field 636 with information describing the source of the data which is being automatically populated into fields 631-635. Here, field 636 contains a statement that the information being automatically populated is based on the information provided in sales orders 1, which was the form for the previous business function.

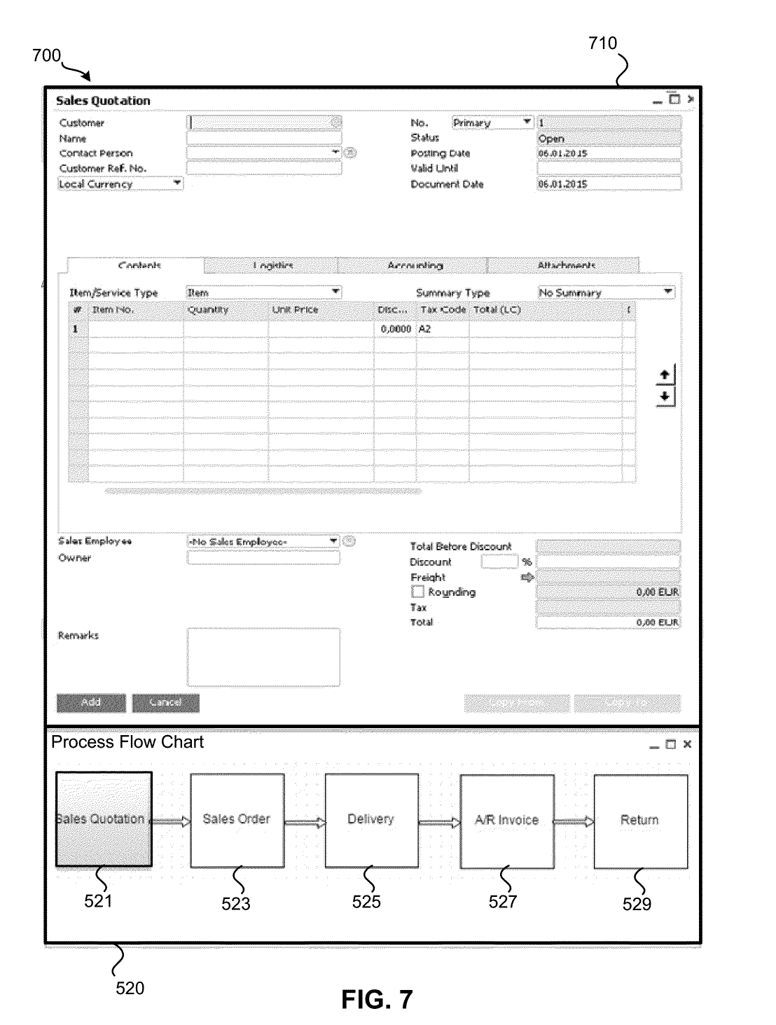

In some embodiments, the process flow chart being presented within the graphical user interface can be configured to receive user interaction. Each business function (i.e., step) presented within the process flow chart can be actionable. When a step within the process flow chart is selected, the corresponding business function can be performed. For example, a form associated with a business function can be presented within the graphical user interface when an icon of the process flow chart that represents the business function is selected. In one embodiment, computer system 100 can determine whether to perform the business function on an existing business object or a new business object. For example, computer system 100 can determine that the selected business function should be performed on an existing business object when the business function selected proceeds the current business function in the process flow chart. For instance, selecting the A/R invoice step 527 in window 520 can result in a form for the A/R invoice business function to be presented within window 510, where the A/R invoice business function is being performed on the business object which the delivery business function was being performed. This can be due to the fact that the A/R invoice business function appears after the delivery function (directly or indirectly) in the process flow chart. Alternatively, computer system 100 can determine that the selected business function should be performed on a new business object when the selected business function takes place prior to the current business function in the process flow chart. For instance, selecting the sales quotation step 521 from window 521 when the current business function is the delivery step 525 can result in computer system 100 presenting a form for the sales quotation step 521 to perform the business function on a new business object. FIG. 7 illustrates a graphical user interface containing a process flow chart according to one embodiment. The form for the sales quotation step 521 is being presented within window 710 of graphical user interface 700. The computer system 100 can regenerate process flow chart in window 720 based on the dependencies with the sales quotation business function. As shown, sales quotation business function 521 is highlighted to indicate that the form being presented within window 710 is related to the sales quotation business function.

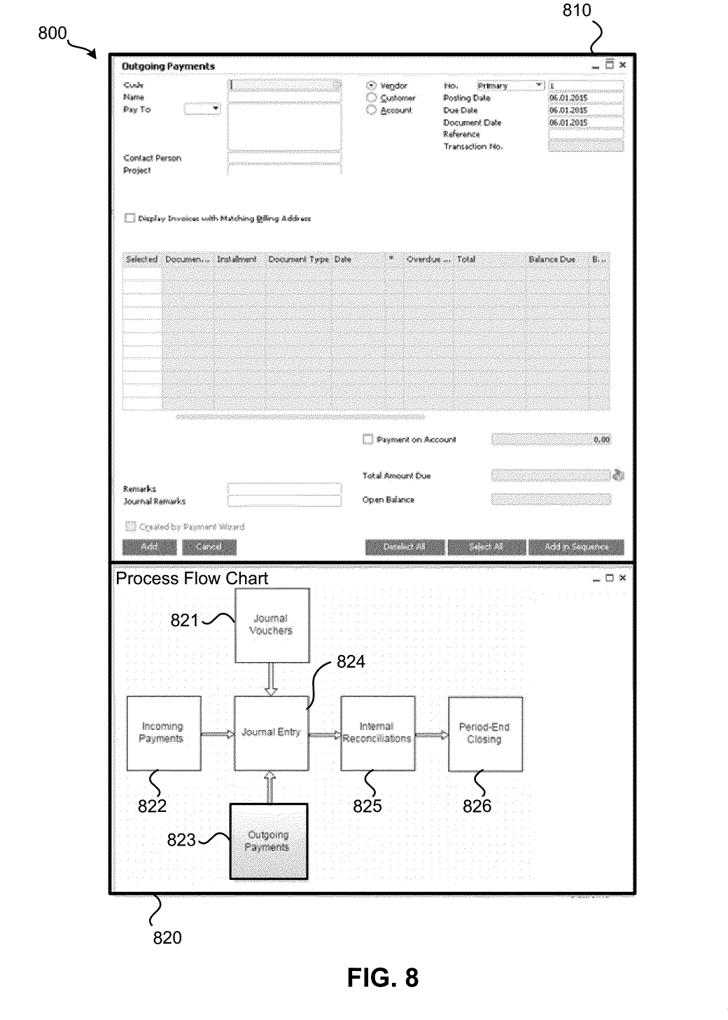

FIG. 8 illustrates a graphical user interface containing a process flow chart according to one embodiment. Graphical user interface 800 includes window 810 for presenting a form associated with a business function and window 820 for presenting a process flow chart that is related to a business activity. Graphical user interface 800 can be presented after the user enters another business function query in the search bar. Upon searching for a different business function, computer system 100 can locate a business function based on the keyword search and present a form for the business function in window 810. The business function can be performed on a new business object since the business function was selected through a keyword search rather than selection of a business function in a process flow chart. Computer system 100 can also generate a process flow chart for the business function. As shown here, process flow chart can be presented within window 820. The process flow chart includes multiple business functions as described in steps 821-826. The business function associated with the form currently being displayed in window 810 can be highlighted (step 823 is highlighted).

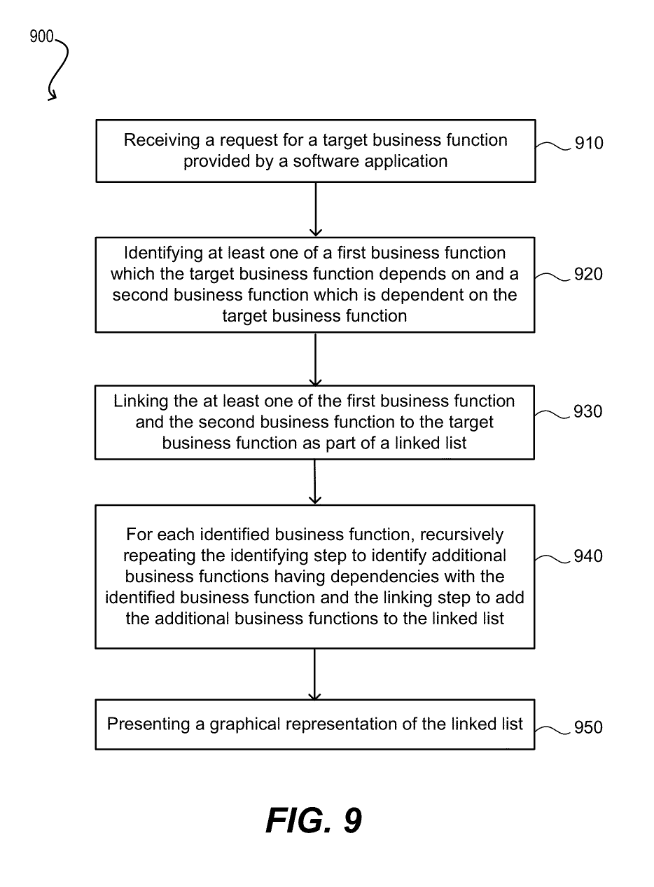

FIG. 9 illustrates a process according to one embodiment. Process 900 can be stored as non-transitory computer readable media and executed by a processor in computing system 100. Process 900 is configured to generate a graphical representation of a linked list of business functions. The graphical representation is the process flow chart. Process 900 begins by receiving a request for a target business function provided by a software application at step 910. In one example, the request is received as input in a keyword search bar. Based on the input, process 900 can identify a business function. The business function can be executed on the software application. In one example, execution of the business function can include the presenting a form for receiving input parameters for the business function.

Process 900 can continue by identifying at least one of a first business function which the target business function depends on and a second business function which is dependent on the target business function at step 920. In one example, process 900 can query a business function database to identify business functions having dependencies with the target business function. In one example, the business function database can identify business functions which the target business function depends on. The target business function can depend on another business function when the other business function generates output which is used as an input parameter for the target business function. In another example, the business function database can identify business functions which depend on the target business function. A business function can depend on the target business function when the business function receives an output parameter of the target business function as input. In other examples, dependency between business functions can be based on their order within a business activity. Each business activity includes multiple business functions that are linked. Dependency can be based on how business functions are linked to one another in the business activity. In some examples, the business function database can have an entry for each business function that is available from software applications within the computer system. Each entry can map a business function to business functions having dependencies with the business function. In one example, each business function can be accompanied with an input function list containing business functions which the target business function depends on and an output function list containing business functions which depend on the target business function.

Once business functions have been identified, process 900 can continue by linking the at least one of the first business function and the second business function to the target business function as part of a linked list at 930. The linked list can connect business functions having direct dependencies with a direct link and business functions having indirect dependencies with an indirect link. A direct link is a direct connection between two business functions (e.g., a single line connecting the two business functions) while an indirect link is an indirect connection between two business functions (the two business functions are connected through multiple lines, where other business functions exist between the two business functions).

Process 900 can continue by recursively repeating the identifying step to identify additional business functions having dependencies with the identified business function and the linking step to add the additional business functions to the linked list at 940. As additional business functions are added to the linked list, the linked list becomes a dependency graph that contains business functions which are directly and indirectly dependent on the target business function. For example the identifying step can have identified a first business function which the target business function depends on and a second business function which depends on the target business function. In step 940, process 900 can first identify additional business functions having dependencies with the first business function. These identified additional business functions can be added to the linked list. Process 900 can then identify additional functions having dependencies with the second business function. These identified additional business functions can also be added to the linked list. This process can recursively repeat until all business functions having direct and indirect dependencies with the target business function have been identified and added to the linked list. These business functions are identified as a collection of business functions.

For example, let's assume that the target business function is “sales quotation” and business functions database 140 in FIG. 3 is used by process 900 to generate the linked list. Process 900 can identify from business functions database that “sales quotation” is an input function while “delivery” is an output function of “sales order.” Thus, “sales order” is directly connected to “sales quotation” and “delivery” within the linked list. Process 900 can then continue by identifying from business functions database that “sales quotation” does not have an input function but has “sales order” for an output function. Since the connection between “sales quotation” and “sales order” already exists within the linked list, this dependency relationship does not need to be added to the linked list. Process 900 can then continue by identifying from business functions database that “delivery” has “sales order” for an input function and “A/R invoice” and “return” for output functions. Since the connection between “delivery” and “sales order” already exists within the linked list, this dependency relationship does not need to be added to the linked list. However, the dependency relationships between “delivery” and “A/R invoice” and “return” can be added to the linked list. Through recursion, the dependency relationship between “A/R invoice and “incoming payment” can also be added to the linked list.

Once the linked list has been generated, process 900 can present a graphical representation of the linked list at 950. In one embodiment, the graphical representation can be multiple icons which each represent a business function within the linked list. The icons can be selectable where selection of an icon can cause the business function to execute. Execution of the business function can include the presentation of a form associated with the business function. In one example, the graphical representation can include an icon which is highlighted through the use of a visual indicator. The highlighted icon can represent the business function which is currently being processed. For example, the highlighted icon can be associated with the form currently being presented simultaneously with the linked list (i.e., process flow chart).

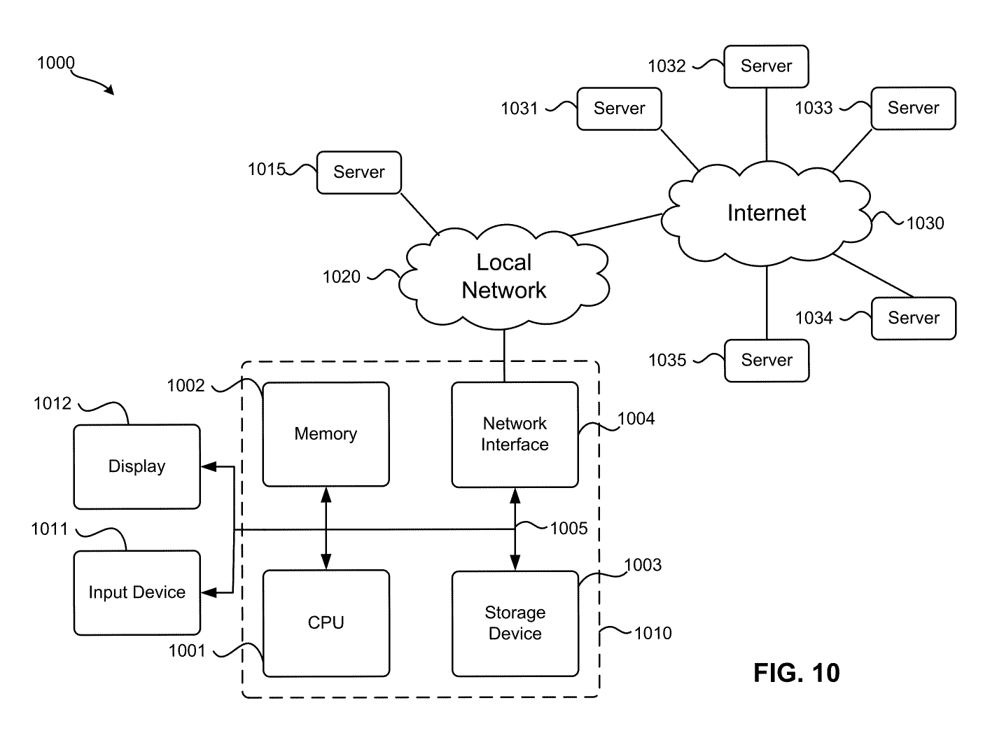

An exemplary computer system 1000 is illustrated in FIG. 10. Computer system 1010 includes a bus 1005 or other communication mechanism for communicating information, and a processor 1001 coupled with bus 1005 for processing information. Computer system 1010 also includes memory 1002 coupled to bus 1005 for storing information and instructions to be executed by processor 1001, including information and instructions for performing the techniques described above, for example. This memory may also be used for storing variables or other intermediate information during execution of instructions to be executed by processor 1001. Possible implementations of this memory may be, but are not limited to, random access memory (RAM), read only memory (ROM), or both. A storage device 1003 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 1003 may include source code, binary code, or software files for performing the techniques above, for example. Storage device and memory are both examples of computer readable mediums.

Computer system 1010 may be coupled via bus 1005 to a display 1012, such as a cathode ray tube (CRT) or liquid crystal display (LCD), for displaying information to a computer user. An input device 1011 such as a keyboard and/or mouse is coupled to bus 1005 for communicating information and command selections from the user to processor 1001. The combination of these components allows the user to communicate with the system. In some systems, bus 1005 may be divided into multiple specialized buses.

Computer system 1010 also includes a network interface 1004 coupled with bus 1005. Network interface 1004 may provide two-way data communication between computer system 1010 and the local network 1020. The network interface 1004 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 1004 sends and receives electrical, electromagnetic, or optical signals that carry digital data streams representing various types of information.

Computer system 1010 can send and receive information, including messages or other interface actions, through the network interface 1004 across a local network 1020, an Intranet, or the Internet 1030. For a local network, computer system 1010 may communicate with a plurality of other computer machines, such as server 1015. Accordingly, computer system 1010 and server computer systems represented by server 1015 may form a cloud computing network, which may be programmed with processes described herein. In the Internet example, software components or services may reside on multiple different computer systems 1010 or servers 1031-1035 across the network. The processes described above may be implemented on one or more servers, for example. A server 1031 may transmit actions or messages from one component, through Internet 1030, local network 1020, and network interface 1004 to a component on computer system 1010. The software components and processes described above may be implemented on any computer system and send and/or receive information across a network, for example.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A computer-implemented method, comprising:
receiving, by a processor, a request for a target business function provided by a software application;
identifying, by the processor, at least one of:
a first business function which the target business function depends on and
a second business function which is dependent on the target business function;
linking, by the processor, the at least one of the first business function and the second business function to the target business function as part of a linked list;
for each identified business function, recursively repeating the identifying step to identify additional business functions having dependencies with the identified business function and the linking step to add the additional business functions to the linked list; and
presenting, by the processor, a graphical representation of the linked list.

2. The computer-implemented method of claim 1, further comprising presenting, by the processor, a form configured to receive an input parameter for the target business function.

3. The computer-implemented method of claim 2, further comprising applying, by a processor, a visual indicator to an icon representing the target business function in the linked list.

4. The computer-implemented method of claim 2, further comprising:
receiving, by the processor, the input parameter;
saving, by the processor, the input parameter;
determining, by the processor and from the linked list, a subsequent business function that depends on the target business function;
presenting, by the processor, a subsequent form associated with the subsequent business function; and
applying, by the processor, a visual indicator to the subsequent business function in the linked list.

5. The computer-implemented method of claim 4, further comprising:
automatically populating, by the processor, a field within a subsequent form with the input parameter.

6. The computer-implemented method of claim 1, wherein the first business function is configured to generate an output parameter which is used as input for the target business function.

7. The computer-implemented method of claim 1, wherein the second business function is configured to receive output generated by the target business function as an input parameter.

8. A non-transitory computer readable storage medium storing one or more programs, the one or more programs comprising instructions for:
receiving a request for a target business function provided by a software application;
identifying at least one of:
a first business function which the target business function depends on and
a second business function which is dependent on the target business function;
linking the at least one of the first business function and the second business function to the target business function as part of a linked list;
for each identified business function, recursively repeating the identifying step to identify additional business functions having dependencies with the identified business function and the linking step to add the additional business functions to the linked list; and
presenting a graphical representation of the linked list.

9. The non-transitory computer readable storage medium of claim 8, further comprising presenting a form configured to receive an input parameter for the target business function.

10. The non-transitory computer readable storage medium of claim 9, further comprising applying a visual indicator to an icon representing the target business function in the linked list.

11. The non-transitory computer readable storage medium of claim 9, further comprising:
receiving the input parameter;
saving the input parameter;
determining from the linked list, a subsequent business function that depends on the target business function;
presenting a subsequent form associated with the subsequent business function; and
applying a visual indicator to the subsequent business function in the linked list.

12. The non-transitory computer readable storage medium of claim 11, further comprising:
automatically populating a field within a subsequent form with the input parameter.

13. The non-transitory computer readable storage medium of claim 8, wherein the first business function is configured to generate an output parameter which is used as input for the target business function.

14. The non-transitory computer readable storage medium of claim 8, wherein the second business function is configured to receive output generated by the target business function as an input parameter.

15. A computer implemented system, comprising:
receiving a request for a target business function provided by a software application;
identifying at least one of:
a first business function which the target business function depends on and
a second business function which is dependent on the target business function;
linking the at least one of the first business function and the second business function to the target business function as part of a linked list;
for each identified business function, recursively repeating the identifying step to identify additional business functions having dependencies with the identified business function and the linking step to add the additional business functions to the linked list; and
presenting a graphical representation of the linked list.

16. The computer implemented system of claim 15, further comprising presenting a form configured to receive an input parameter for the target business function.

17. The computer implemented system of claim 16, further comprising applying a visual indicator to an icon representing the target business function in the linked list.

18. The computer implemented system of claim 16, further comprising:
receiving the input parameter;
saving the input parameter;
determining from the linked list, a subsequent business function that depends on the target business function;
presenting a subsequent form associated with the subsequent business function; and
applying a visual indicator to the subsequent business function in the linked list.

19. The computer implemented system of claim 15, wherein the first business function is configured to generate an output parameter which is used as input for the target business function.

20. The computer implemented system of claim 15, wherein the second business function is configured to receive output generated by the target business function as an input parameter.
